(19) United States
(12) Patent Application Publication
(10) Pub. No.: US 2005/0237558 A1
(43) Pub. Date: Oct. 27, 2005

(54) Accessing a presentation device using a printing infrastructure

(76) Inventors: Keith E. Moore, Sunnyvale, CA (US); Emiliano Bartolome, Pontevedra (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/832,122

(22) Filed: Apr. 26, 2004

(51) Int. Cl. G06F 15/00

(52) U.S. Cl. 358/1.13

(57) ABSTRACT

Techniques for employing a printing infrastructure to access a presentation device. A presentation system according to the present teachings includes a presentation device with a display and a mechanism for rendering an image on the display in response to a print file. A client system according to the present teachings provides the print file to the presentation device using an existing printing infrastructure, thereby obviating the need for a base computer or specialized client system software.

### BACKGROUND

Presentation devices may be used to display computer-generated images. One example of a presentation device is a projector that may be used to display computer-generated images to an audience. Other types of presentation devices that may be used to display computer-generated images may include flat-panel displays, CRT displays, as well as other types of devices.

A presentation device may be accessed by one or more computer systems that generate images to be displayed on the presentation device. A computer system that generates images for display on a presentation device may be referred to as a client system of the presentation device. A client system may execute one or more application programs that generate images for display on a presentation device.

A prior method for providing a client system with access to a presentation device is to employ a base computer system or similar device that functions as a server for accessing the presentation device. Each client system that is to access the presentation device may be provided with specialized software that enables communication with the presentation device via the base computer system. Unfortunately, the specialized software on a client computer system may limit the accessibility of a presentation device. For example, a client system that does not have the specialized software installed or that does not have the proper software version may be prevented from using a presentation device. Moreover, software and configuration requirements may vary among different presentation devices and client systems and communication environments etc., which may further complicate access to a presentation device.

### SUMMARY OF THE INVENTION

Techniques are disclosed for employing a printing infrastructure to access a presentation device. A presentation system according to the present teachings includes a presentation device with a display and a mechanism for rendering an image on the display in response to a print file. A client system according a to the present teachings provides the print file to the presentation device using an existing printing infrastructure. Providing a print file to a presentation device using an existing printing infrastructure that is inherently supported by a wide variety of computer systems and application programs obviates the need for a base computer system for a presentation device or specialized software in clients systems for accessing the presentation device.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a presentation system according to the present teachings;

FIG. 2 shows one embodiment of a presentation device according to the present teachings;

FIG. 3 shows another presentation system according to the present teachings.

### DETAILED DESCRIPTION

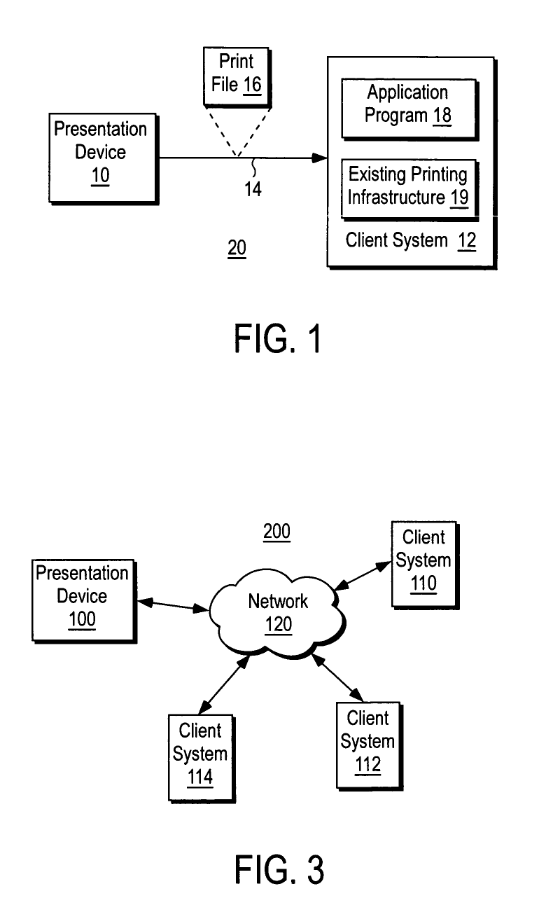

FIG. 1 shows a presentation system 20 according to the present teachings. The presentation system 20 includes a presentation device 10 and a client system 12 that communicate via a communication path 14.

The client system 12 executes an application program 18 that generates images, e.g. graphs charts, text, and that employs the presentation device 10 to display the images. The application program 18 accesses the presentation device 10 using an existing printing infrastructure 19 of the client system 12. The existing printing infrastructure 19 is used to provide the presentation device 10 with a print file 16 containing the images to be displayed to the presentation device 10. The presentation device 10 obtains the print file 16 via the communication path 14 and then renders the images specified in the print file 16 onto a display of the presentation device 10.

The existing printing infrastructure 19 provides printing support in the client system 12 for application programs including the application program 18. The existing printing infrastructure 19 may include a printer driver program along with facilities provided by an operating system of the client system 12 for accessing the printer driver program. The facilities of the client system 12 operating system may include facilities for installing printers and corresponding printer driver programs and for selecting printers for use by application programs as well as a spooling mechanism for sending print files to a printer.

For example, the operating system of the client system 12 may provide graphics device interface (GDI) system calls that may be used by application program 18 to generate images. The operating system of the client system 12 may redirect the GDI calls generated by the application program 18 when a user selects a print command in the application program 18 to a device driver interface (DDI) for a selected printer. The DDI for a selected printer provides the GDI calls from the application program 18 to the printer driver for the presentation device 10 when it is the selected printer.

The printer driver for the presentation device 10 may generate the print file 16 by converting the intercepted GDI calls from the application program 18 to a standard printing format. Examples of a standard printing format include Postscript, Printer Command Language (PCL), Postscript Display Format (PDF), and Enhanced Meta Format (EMF). Other example formats for use by the presentation device 10 include JPEG, TIFF, and GIF formats. A spooling mechanism of the client system 12 may be used to transfer the print file 16 to the presentation device 10.

The print file 16 may specify multiple images to be displayed on the presentation device 10. A time interval may be associated with displaying the multiple images such that the presentation device 10 sequentially switches among the images according to the time interval.

The print file 16 may specify the time interval associated with displaying the multiple images. The time interval for displaying multiple images may be implemented using a timer contained in the presentation device 10. The time interval in the timer in the presentation device 10 may be set via user input, e.g. the presentation device 10 may include a remote control user interface mechanism that enables access to the timer. The time interval for displaying multiple images may be set via a set of printing options in a printer configuration page for the presentation device 10. The time interval for displaying multiple images may be set by a printer driver executing on the client system 10 for the presentation device 10.

The presentation device 10 in some embodiments provides a user interface that enables a user to move the image display of the presentation system 10 forward to a next image in the print file 16 and back to a previous image in the print file 16.

The presentation device 10 may store the print file 16 internally and then render the images in response to a time interval or user input. Alternatively, the presentation device 10 may obtain the print file 16 one page at a time and render the image in each obtained page and issue page forward and page back requests via the spooling mechanism of the existing printing infrastructure 19.

The client system 12 may be computer system, e.g. personal computer, workstation, handheld computer, etc., or a PDA or other device that supports an existing printing infrastructure to which application programs may be adapted. The fact that the application program 18 and the client system 12 are adapted to the existing printing infrastructure 19 obviates the need to implement specialized software on the client system 12 to employ the presentation device 10. Any application program executing on any client system having an existing printing infrastructure may employ the presentation device 10 using the present techniques.

The communication link 14 may be any type of communication link including communication links that are commonly used for communication with printers. Examples include network communication links, e.g. Ethernet, serial and parallel wire-based links, as well as wireless links.

The presentation device 10 when connected to the communication link 14 conforms to a plug/play protocol of the existing printing infrastructure 19 and is recognized as a printer by the client system 12.

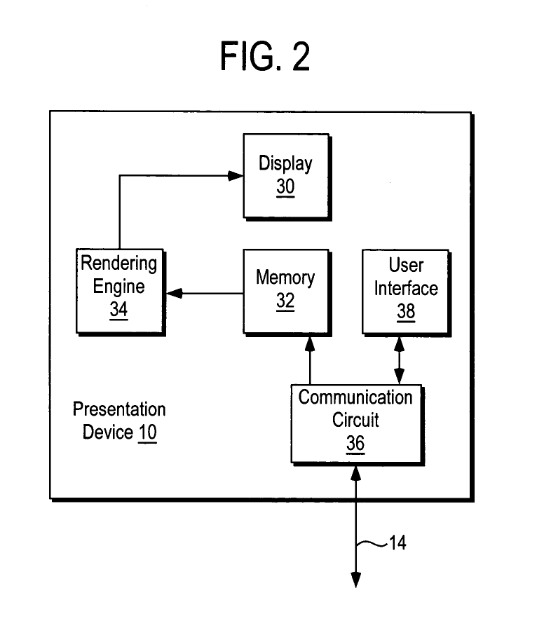

FIG. 2 shows one embodiment of the presentation device 10. The presentation device 10 includes a communication circuit 36 that enables communication via the communication path 14 and a memory 32 for storing the print file 16 that is received via the communication path 14.

The presentation device 10 includes a rendering engine 34 that renders the images, i.e. printer pages, defined in the print file 16 onto a display 30. The display 30 may be a projector, panel display, CRT display, etc. The rendering engine 34 renders images from the print file format, e.g. Postscript, PCL, PDF, EMF, to a resolution that is adapted to the display 30.

The memory 32 may have enough capacity to store all the pages in the print file 16. If the memory 32 is relatively small or non-existent then the presentation device 10 may signal a jam via the communication link 14. The jam signal causes the existing printing infrastructure 19 to resend pages so that they need not be stored in the presentation device 10.

The memory 32 may be large enough to store large numbers of images received via the existing printing infrastructure 19. For example, a disk drive or other large storage media in the presentation device 10 may enable storage and retrieval and replay of entire presentations.

The presentation device 10 in this embodiment includes a user interface 38 that enables a user to move forward and back through the images that are defined in the print file 16. The user interface 38 may be implemented in any manner. For example, panel buttons may be provided on the presentation device 10 for manual control. Alternatively, the user interface 38 may communicate via the communication circuit 36 and the communication link 14 to a user input window on the client system 12. The user input window may include buttons that enable a user to move forward and back through the images in the print file 16. The user interface 38 may include mechanisms for communicating with a handheld remote control, e.g. wireless, RF link, etc.

FIG. 3 shows a presentation system 200 according to the present teachings. The presentation system 200 includes a presentation device 100 and a set of client systems 110-114 that access the presentation device 100 via a network 120.

The presentation device 100 includes a network communication card and is configured as a networked printer that is accessible via the network 120. Each client system 110-114 includes an operating system and network communication elements that are able to recognize the presentation device 100 as a printer along with an existing printing infrastructure that enables application programs to select and print to the presentation device 100 via the existing printing infrastructure.

The client systems 110-114 may include an assortment of computer systems and other devices having an existing printing infrastructure to which their application programs may be adapted. The fact that the application programs on the client systems 110-114 access the presentation device 100 using existing printing infrastructures obviates the need to implement specialized software on the client systems 110-114 or to provide a base computer system for the presentation device 100 for accessing the presentation device 100.

In the existing printing infrastructure 19, the GDI (Graphics Device Independent) calls generated by the application program 18 represent a set of library calls that are independent of any specific underlying printing device. The GDI calls are associated by the operating system of the client system 12 to a DDI (Device Driver Interface) printer driver that has a set of similar entry points. Each GDI call has an associated DDI entry point.

In one embodiment, when a printer is installed in the operating system, it is associated with a printer driver. If the printer is selected, then the associated printer driver is also selected. The application program 18 can thus discover margins, fonts, and other device specific characteristics by asking the opened printer for its capabilities.

The application program 18 makes calls on the GDI layer and the GDI layer converts these calls into operating system calls which are dispatched into the DDI entry points of a device driver that has been loaded into the operating system. The device driver then converts the incoming call into the device dependent representation of that call (or set of calls), e.g. converting a Status DrawLine (const Pen *pen, const Point &pt1,const Point &pt2) call into a PCL escape sequence.

The existing printing infrastructure 19 includes a set of functionality provided to control overall print job operations, e.g. spooling the job, setting the priority of job, setting the title/owner of job, and controlling permissions, etc. The print job control functionality may be implemented as a file transfer utility that migrates a print file from one machine to another (remote spooling) and controls the order of a print job on a local machine.

An EMF (Enhanced Meta-Format) may be used for encoding the GDI calls into a log file and then sending the log file via a file-copy mechanism to a remote server or printer. The remote server, e.g. a print spooler receives the log file and then re-issues the GDI calls on a local print driver that turns the calls into printer specific instructions.

The application program 18 provides an image to the presentation device 10 via the existing printing infrastructure 19 as follows. The application program 18 opens the presentation device 10 and inquires through the GDI layer about configuration parameters. The GDI layer converts these calls into operating system calls that are then redirected to the DDI layer of the driver registered for the presentation device 10. The driver interprets the incoming call and responds with any default parameters. The application program 18 then makes additional calls on the GDI library. These calls are converted into operating system calls and then into DDI invocations on the driver associated with the presentation device 10. The driver then converts the DDI invocations into encoding sequences in the print file 16 for the presentation device 10. The print file 16 may be sent immediately to the presentation device 10 or spooled using the remote spool mechanism. The presentation device 10 receives the print file 16, e.g. in EMF, PS or RAW format, and converts this format into rendering commands that are displayed/projected.

The foregoing detailed description of the present invention is provided for the purposes of illustration and is not intended to be exhaustive or to limit the invention to the precise embodiment disclosed. Accordingly, the scope of the present invention is defined by the appended claims.

1. A presentation system, comprising:
presentation device having a display and a mechanism for rendering an image on the display in response to a print file;
client system that provides the print file to the presentation device using an existing printing infrastructure of the client system.

2. The presentation system of claim 1, wherein the presentation device switches to a next image in the print file according to a time interval.

3. The presentation system of claim 2, wherein the time interval is specified in the print file.

4. The presentation system of claim 2, wherein the time interval is specified in a timer in the presentation device.

5. The presentation system of claim 2, wherein the time interval is specified by a printer driver associated with the presentation device.

6. The presentation system of claim 2, wherein the time interval is specified in a printer configuration page for the presentation device.

7. The presentation system of claim 1, wherein the presentation device provides a user interface that enables a user to move among rendering a number of images in the print file.

8. The presentation system of claim 1, wherein the presentation device renders the image in response to a specification of a page contained in the print file.

9. The presentation system of claim 1, wherein the presentation device includes a memory that stores the print file.

10. The presentation system of claim 1, wherein the printing infrastructure includes a printer driver that converts the image from a representation used by an application program to a representation used by the presentation device.

11. A presentation device having a display and a mechanism for rendering an image on the display in response to a print file obtained from a client system using an existing printing infrastructure of the client system.

12. The presentation device of claim 11, further comprising a timer for switching to a next image in the print file according to a time interval in the timer.

13. The presentation device of claim 11, further comprising a user interface that enables a user to move among rendering a number of images in the print file.

14. The presentation device of claim 11, wherein the presentation device includes a memory that stores the print file.

15. A method for presentation, comprising the steps of:
generating a print file using an existing printing infrastructure of a client system;
rendering an image on a display in response to the print file.

16. The method of claim 15, further comprising the step of switching to a next image in the print file in response to a time interval.

17. The method of claim 16, wherein the step of generating a print file includes the step of specifying the time interval in the print file.

18. The method of claim 16, further comprising the step of setting a timer for holding the time interval.

19. The method of claim 15, further comprising the step of generating a user interface that enables a user to move among rendering a number of images in the print file.

20. The method of claim 15, further comprising the step of converting the image from a representation used by an application program to a representation for rendering on the display.
